(19) United States
(12) Patent Application Publication
(10) Pub. No.: US 2026/0042868 A1
(43) Pub. Date: Feb. 12, 2026

(54) Methods of Extraction of Carboxycellulose Nanofibers from Virgin Plant Materials

(71) Applicant: Board of Trustees of Western Michigan University, Kalamazoo, MI (US)

(72) Inventor: Priyanka Sharma, Portage, MI (US)

(21) Appl. No.: 19/296,842

(22) Filed: Aug. 11, 2025

Related U.S. Application Data
(60) Provisional application No. 63/681,515, filed on Aug. 9, 2024.

(51) Int. Cl. C08B 15/00; C08B 1/00

(52) U.S. Cl. CPC C08B 15/00; C08B 1/003

(57) ABSTRACT

Aspects of the present disclosure may include a method to produce carboxylate-rich lignified cellulose nanofibers from plant fiber biomass, including: combining plant fiber biomass, TEMPO agent and NaBr in water; adding NaClO to said water, at a concentration of at least 20 mmol per g of biomass to form a reaction mixture; obtaining a reacted plant fiber biomass; and homogenizing the reacted plant biomass to form carboxylate-rich lignified cellulose nanofibers.

### CROSS REFERENCE TO RELATED APPLICATIONS

This application claims priority to U.S. Provisional No. 63/681,515, filed Aug. 9, 2024, the content of which is claimed by reference in its entirety.

### BACKGROUND OF THE INVENTION

TEMPO-mediated oxidation is the most popular approach to extracting carboxylated cellulose nanofibers (CNFs) from cellulose fibers (pulps). The present disclosure describes in some aspects a novel modified TEMPO/NaBr/NaClO oxidation method to extract CNFs from virgin jute fibers that have not undergone any pretreatment process (e.g., de-lignification and pulping) before the introduction of the TEMPO-oxidation process. This one-pot approach combines the steps of delignification/pulping and cellulose oxidation.

### BRIEF SUMMARY OF THE INVENTION

Aspects of the present disclosure may include a method to produce carboxylate-rich lignified cellulose nanofibers from plant fiber biomass, including: combining plant fiber biomass, TEMPO agent and NaBr in water; adding NaClO to said water, at a concentration of at least 20 mmol per g of biomass to form a reaction mixture; obtaining a reacted plant fiber biomass; and homogenizing the reacted plant biomass to form carboxylate-rich lignified cellulose nanofibers.

In other aspects obtaining a reacted plant fiber biomass further includes quenching the reaction with an alcohol. In others, the alcohol is ethanol. In yet others, the alcohol is added at about a 1:3 ratio to the original amount of water.

In yet others, obtaining a reacted plant biomass further comprises achieving a pH at about 10 to 10.5 in the reaction mixture. In others, the plant fiber biomass is ground into fibers of about 2-4 mm or less.

In others, the plant fiber biomass is added to the reaction mixture at 2.0% wt/vol of water or less. In yet others, the TEMPO agent is added to the reaction mixture at 0.1% wt/vol of water or less. In others, the NaBr is added to the reaction mixture at 0.5% wt/vol of water or less. In others, the NaClO is added to said water, at a concentration of at least 24 mmol per g of biomass.

In others, the NaClO is added to said water, at a concentration of about 20-50 mmol per g of biomass. In yet others, the carboxylate-rich lignified cellulose nanofibers have an overall removal of lignin and hemicellulose by more than 90%, compared to the initial plant fiber biomass. In yet others, the carboxylate-rich lignified cellulose nanofibers have a carboxylate content of about 1.30 mmol/g or more.

### BRIEF DESCRIPTION OF THE DRAWINGS

FIG. 1 depicts the mechanism of TEMPO/NaBr/NaClO oxidation on cellulose and hemicellulose;

FIG. 2 depicts the FTIR spectra of cellulose nanofibers (CNFs) with various carboxylate content;

FIG. 3 shows the ¹³C CPMAS NMR spectra of CNFs with various carboxylate content;

FIG. 4 depicts thermogravimetry analysis (TGA) profiles with various carboxylate content;

FIG. 5 shows derivative thermogravimetry (DTG) profiles of CNFs with various carboxylate content;

FIG. 6 depicts wide-angle X-ray diffraction (WAXD) plots of CNFs with various carboxylate content;

FIG. 7 shows TEM images of (i) CNF (0.131 mmol/g), (ii) CNF (0.175 mmol/g), and (iii) CNF (1.18 mmol/g);

FIG. 8 shows (left column) AFM images and (right column) cumulative frequency counts are indicative of the thickness distribution for (i) CNF (0.131 mmol/g), (ii) CNF (0.175 mmol/g), and (iii) CNF (1.18 mmol/g);

FIG. 9 shows contact angle measurements of (a) CNF (0.131 mmol/g), (b) CNF (0.175 mmol/g), and (c) CNF (1.18 mmol/g)

FIG. 10 shows UV-vis spectra of nanopapers prepared from CNFs with various carboxylate content;

FIG. 11 shows BET measurements of CNFs nanopapers.

### DETAILED DESCRIPTION OF THE INVENTION

TEMPO (2,2,6,6-tetramethylpiperidin-1-oxyl)-mediated oxidation of cellulose has been widely used by researchers to prepare carboxylated cellulose nanofibers (CNFs). (Isogai et al. 2011; Lin et al. 2014; Rodionova et al. 2012; Saito et al. 2006; Sehaqui et al. 2011; Shimizu et al. 2013; Shinoda et al. 2012; Su et al. 2014; Su et al. 2015; Thodikayil et al. 2024) Uses of CNFs from TEMPO-mediated oxidation have recently been demonstrated in many applications such as water purification, (Ma et al. 2012a, b; Ma et al. 2011) nanocomposites, (Koga et al. 2013) nano-paper, (Lay et al. 2017; Sehaqui et al. 2011) ultra-porous lightweight foams and aerogels, (Cervin et al. 2013; Lin et al. 2014; Lin et al. 2012) gas barrier films, and energy storage applications. (Rodionova et al. 2012; Shah and Imae, 2016) TEMPO oxidation is a mild oxidation process, inducing defibrillation through electron repulsion. The resulting nanofibers possess relatively narrow widths (˜4 nm), long lengths (>1 μm), and high aspect ratios (>250). The process generally preserves the aggregation of elementary microfibrils in nanofibers with oriented cellulose chains and crystalline structure, thus yielding high elastic moduli. (˜140 GPa). (Shinoda et al. 2012)

In general, the oxidation of cellulose polymers leads to partial modification where only surface hydroxyls cover carboxylate groups (negative surface charge), and the negative surface charge causes repulsion during mechanical defibrillation, leading to nanofibers. Defibrillation can be performed by mechanical means such as via a high-pressure homogenizer and ultrasonication. TEMPO oxidation of cellulose fibers can be performed at neutral (pH ˜7) or basic conditions (PH ˜10). TEMPO oxidation is usually carried out under basic conditions at room temperature, whereby the addition of NaBr and NaClO to the TEMPO agent generates nitrosonium ions, which assist the selective oxidation of the primary hydroxyl group at the C6 position in the cellulose fiber surface. The resulting carboxylated cellulose fibers then can be mechanically disintegrated in water, using a homogenizer to create a homogeneous suspension of CNF. There are several studies that investigate the effect of different compositions of reactants in TEMPO oxidation to extract the CNF, including TEMPO/NaBr/NaClO/NaClO₂, (Tanaka et al. 2012) TEMPO/NaBr/NaClO, (DiFlavio et al. 2007) Lacasse/TEMPO (Fabbrini et al. 2001). Generally, all the above compositions effectively defibrillate cellulose fibers into CNF. However, optimal conditions vary with the cellulose source.

As stated above, the mechanism of TEMPO-mediated oxidation to extract CNFs from cellulose pulps (i.e., free of lignin and hemicellulose) has been well documented, (Isogai et al. 2011) but very few reports have been made on virgin fibers. There are several reports discussing the usage of TEMPO-mediated oxidation to extract CNF from various biomass sources. (Isogai et al. 2011; Lin et al. 2014; Rohaizu and Wanrosli 2017; Saito et al. 2006a,b) It is found that using woody biomass, such as softwood and hardwood, often needs pretreatments such as delignification and pulping. The typical pretreatment procedures include solvents, (Tian et al. 2017) alkali, (Langan et al. 1999) bleaching, (Zhang et al. 2015), and steam/ammonia extraction. (Habibi et al. 2010) These procedures are recommended (or not) depending on the source of biomass used. (Brinchi et al. 2013; Morán et al. 2007) In some instances, lengthy extraction procedures, such as several bleaching steps, are required to remove lignin, hemicellulose, and other components from plant biomass. (Watkins et al. 2015) The increase in the number of steps inevitably increases CNF production cost. Hence, many efforts have been made to identify more cost-effective and simpler pathways to generate CNF from wood biomass. (Awang et al. 2018; Filipova et al. 2020; Kumar et al. 2020; Kumar et al. 2019; Wang et al. 2020)

Recently, a cost-effective, simple, less-chemically oriented nitro-oxidation process (NOP) has been developed to extract CNFs from virgin (raw) non-woody plant biomass. (Sharma et al. 2017a,b; Sharma et al. 2018) This NOP involves using nitric acid (HNO3)/sodium nitrite (NaNO2) mixtures, where HNO3 acts as a pulping solvent and NaNO2 as an oxidizing agent. The NOP combines the processes of pulping and cellulose oxidation in one pot. Therefore, the process significantly decreases the consumption of water, energy, and chemicals for CNF production from virgin plant fibers. (Chen et al. 2022a, b; Chen et al. 2021; Duceac et al. 2022; Rwegasila et al. 2024; Sharma et al. 2017 a, b; Sharma et al. 2018; Sharma et al. 2020; Sharma et al. 2022; Zhan et al. 2019) Similarly, spherically shaped carboxylated cellulose was also produced using nitric acid and phosphoric acid treatments. (Carvalho et al. 2021; Meyabadi et al. 2014; Purkait et al. 2011; Sharma et al. 2014a, b, c)

Inspired by the development of the NOP, the present disclosure improves the efficiency of the TEMPO-mediated oxidation to extract CNFs from virgin plant fibers, i.e., (untreated jute fibers). The typical TEMPO/NaBr/NaClO conditions used to treat bleached kraft pulps and cotton linter, using an excess reactant: sodium hypochlorite (NaClO). Surprisingly, a higher amount of NaClO can simultaneously assist in the delignification, bleaching (removal of extractives, lignin, and hemicellulose), and cellulose oxidation steps. Recently, a study carried out by Matsuki et al. indicated that a one-pot oxidation reaction using only a highly concentrated solution of NaClO and subsequent mechanical treatment can effectively extract CNF from wood pulp by oxidizing the C2 and C3 hydroxy groups of the glucose units (Matsuki et al. 2020), which may indirectly correlate to the mechanism seen here.

In aspects of the current disclosure, the chosen amount of NaClO was 5-8 times higher than those typically used in the literature. (Isogai et al. 2011), enabling the extraction of nanocellulose directly from suitable raw biomass (e.g., jute fibers) rather than neat cellulosic biomass with the proper TEMPO oxidation conditions. Thus far, the TEMPO approach for CNF extraction has not been reported using untreated lignocellulosic biomass, rather requiring pre-bleached fibers (Di et al. 2018; Hillscher et al. 2024; Levanič et al. 2020).

The process described herein demonstrates the use of virgin plant fibers, without any pretreatment to generate lignocellulose and cellulose nanofibers with carboxyl functionality using TEMPO-mediated oxidation. Here, with the disclosed method, no pretreatment is required to extract cellulose from biomass, which is prescribed in most of the conventional processes such as carboxymethylation, traditional TEMPO oxidation, periodate treatment, and others. Further, the pretreatment of plant fibers usually consists of alkalization and multi-step bleaching processes to removing other components, such as lignin and hemicellulose from biomass prior to cellulose extraction. These steps include the use of multiple toxic chemicals, such as sodium hydroxide, sodium chlorite, dimethyl sulfoxide etc. along with the consumption of high amount of water and electrical energy, whereas the current method significantly reduces the process steps, leading to lower consumption of chemicals, energy and water. For instance, the materials cost of a standard TEMPO-CNF is expensive (for example, approximately 5 gallon/$450, figures from U Maine). Using the proposed method, the cost may be reduced by 30-40%.

The proposed method leads to the generation of primarily lignocellulosic fibers with carboxy functionality, which is a vital new class of material suitable for myriad applications, including water purification, nanocomposites, drug delivery, hemostatic material, fabrication of solar cell, fuel cell membrane, catalyst carrier, electronic paper, barrier layer, adsorbent, sensors etc. Hence, the production of lignocellulosic fibers using this low cost approach with all types of plant biomass (woody/non-woody; value/no-value) will greatly enhance the economic, environmental and societal impacts of these materials, especially when there is an immense requirement for sustainable technologies.

Three CNF samples with different degrees of oxidation (carboxylate content of 1.18, 0.175, and 0.131 mmol/g) were prepared by the addition of varying amounts of NaClO (i.e., 48, 32, and 24 mmol/g, respectively), where the content of NaClO was found to affect the delignification efficiency on raw fibers. Specifically, CNF (0.131 mmol/g) possessed a residual lignin content of 2% and hemicellulose of 2.5%; CNF (0.175 mmol/g and 1.18 mmol/g) lignin at 1.9% and hemicellulose at 2.3%. The results indicate that using excess NaClO could lead to the generation of nitroxonium ions, which selectively oxidize the hydroxyl groups in cellulose, hemicellulose, and lignin. As a result, this excess usage of NaClO (32-48 mmol/g) during the TEMPO/NaBr/NaClO process was more effective in delignification and hemicellulose removal. FTIR, 13C CPMAS-NMR, WAXD, contact angle, AFM, TEM, and BET techniques were used to characterize all extracted CNFs. The CNFs showed an average length of 1000 nm and a width of 6 nm.

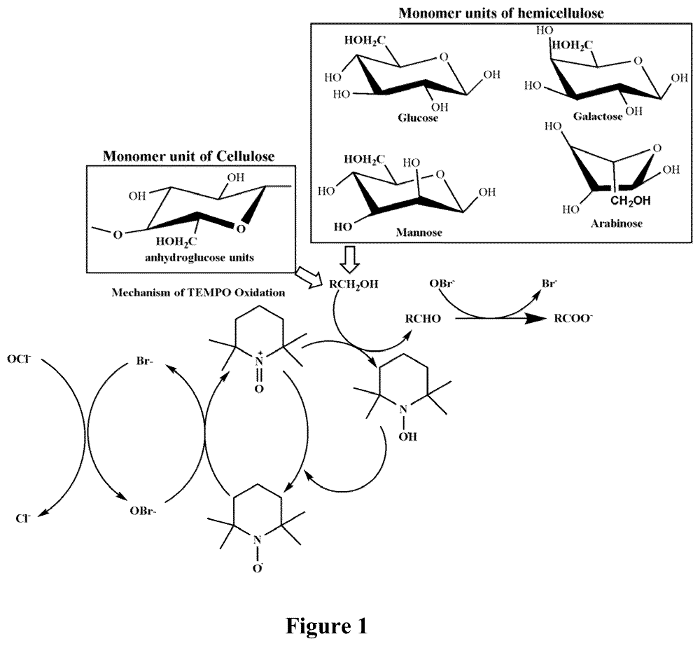

The mechanism of the TEMPO/NaBr/NaClO oxidation process of both monomer units of cellulose and hemicellulose is presented in FIG. 1. In this diagram, the actual oxidant is N-oxaammonium salt, which is associated with NaBr and NaClO and can oxidize the primary hydroxyl groups into carboxyl groups. Here, it is disclosed that the excess amount of NaClO can assist in removing lignin and hemicellulose components from virgin jute fibers. NaClO is a well-known delignifying agent for wood fibers. For example, it has been reported that NaClO, even with 8 mmol/g concentration, can cause effective lignin and hemicellulose removal from several lignocellulosic biomasses. (Hubbell and Ragauskas 2010) In aspects of the present disclosure, NaClO concentrations in the range of 24-48 mmol/g, were used, which are 5-8 times higher than the NaClO concentration typically used in the TEMPO-mediated oxidation for CNF extraction. (Isogai et al. 2011) As a result, these current TEMPO oxidation conditions with an excess amount of NaClO can provide the effective oxidation of cellulose and the effective strategy for lignin hemicellulose removal in a one-pot system.

### EXAMPLES

Materials. GPack Enterprises in India provided virgin jute fibers (degree of polymerization (DP) of extracted cellulose 600). Fibers were ground using the commercial grinder to get a 2-4 mm fiber length. Analytical grade sodium hypochlorite (NaClO-12 wt %)-ACS reagent, 65%; sodium bromide (NaBr)-ACS reagent ≥97%; TEMPO agent-ACS reagent 98%; sodium hydroxide (NaOH)-ACS reagent ≥97%, were purchased from Sigma Aldrich. All chemicals were used without further purification.

Example 1. Preparation of CNF. CNFs were prepared based on modifying previously reported methods (Shinoda et al. 2012) in TEMPO/NaBr/NaClO oxidation at pH=10-10.5 and room temperature. Three sets of experiments were performed; each experiment contained virgin ground jute fibers (25 g) suspended in water (1500 mL), TEMPO agent (1 g), and NaBr (5 g). Three different concentrations of NaClO solution (24, 32, and 48 mmol/g) were used. The mixture was stirred and maintained at pH=10-10.5 by addition of 0.1 M NaOH (we note that the initial pH value of the mixture was unstable for 30-45 minutes depending on the amount of NaClO used, where the variation in pH usually became stable at pH ˜11). The dropwise addition of 0.1M NaOH was begun immediately after the pH value reached around 10. The reaction was sustained for 24 h at room temperature and then was quenched using 500 mL of ethanol. A slurry of the TEMPO-oxidized (0.2 wt %) jute fibers was then passed through a high-pressure homogenizer (IKA Labor Pilot 2000/4 homogenizer) at 200 bars, 1 cycle to obtain CNFs. CNF separation was carried out using the procedures demonstrated in Shinoda et al., 2012.

Table 1 summarizes the characteristics and properties of all CNF samples prepared using the current TEMPO/NaBr/NaClO oxidation method, assessed using the methods in the following Examples.

TABLE 1
Summarized properties of different CNFs prepared using a varying
amount of NaClO in the TEMPO/NaBr/NaClO oxidation process.

| | | | | | BET | | |
|---|---|---|---|---|---|---|---|
| | NaClO | Carboxylate | Aldehyde | Zeta | surface | Lignin | Hemicellulose |
| | conc. | Cont. | content | potential | area | content | content |
| Sample | (mmol/g) | (mmol/g) | (mmol/g) | (mV) | (m²/g) | % | (%) |
| Jute | — | — | — | — | — | 17.6 | 11.7 |
| fibers | | | | | | | |
| CNF | 24 | 0.131 | 0.10 | −110 | 5.7 | 2 ± 1.5 | 2.5 ± 0.6 |
| (0.131 | | | | | | | |
| mmol/g) | | | | | | | |
| CNF | 32 | 0.175 | 0.18 | −114 | 10.5 | 1.9 ± 1.8 | 2.3 ± 0.6 |
| (0.175 | | | | | | | |
| mmol/g) | | | | | | | |
| CNF | 48 | 1.18 | 1.50 | −148 | 10.7 | 1.9 ± 1.9 | 2.3 ± 0.6 |
| (1.18 | | | | | | | |
| mmol/g) | | | | | | | |

Example 2. Determination of Carboxylate and Aldehyde content. The carboxyl content in the CNFs was determined by using the conductivity titration method. This method added 0.1 M hydrochloric acid solution to 100 g of a 0.1 wt % CNF suspension until the pH value reached 2.8. The CNF suspension was then stirred at 450 rpm for 30 minutes and titrated with 0.1 M NaOH until the pH reached 10.7. The conductivity was measured after each 0.5 mL addition of the NaOH solution (0.1 M) into the CNF suspension using ta conductivity meter during titration. The carboxylate content for CNFs was calculated from conductivity and pH curves. (Su et al. 2014)

Aldehyde content in the virgin jute fibers and CNF was determined using the method described in Saito et al. (2006a, b). In brief, this method treated the sample with sodium chlorite (NaClO₂) at pH=4 for 48 h. The sample was washed and titrated using conductivity titration to measure the carboxylate content. The difference in the carboxylate content values before and after the NaClO₂ treatment was considered as the aldehyde content.

Lignin and hemicellulose (total sugar) analyses of the samples (virgin jute fibers and CNF) were performed. The following analytical procedures were used in the analysis: (1) acid hydrolysis of samples, (2) determination of acid-soluble lignin (ASL) using UV-visible spectroscopy, (3) gravimetric determination of klaxon lignin (KL), and (4) chromatographic analysis of hydrolysate.

Carbohydrate and aldehyde content as well as lignin and hemicellulose % are presented in Table 1.

Example 3. Fourier Transform Infra-Red Spectrometry (FTIR). A ThermoFisher spectrometer was used to record the FTIR curves in the transmission mode, between 450 and 4000 cm-1. A total of 12 scans were taken per sample with a resolution of 4 cm⁻¹. The solid samples were recorded in the Attenuated Total Reflectance (ATR) mode.

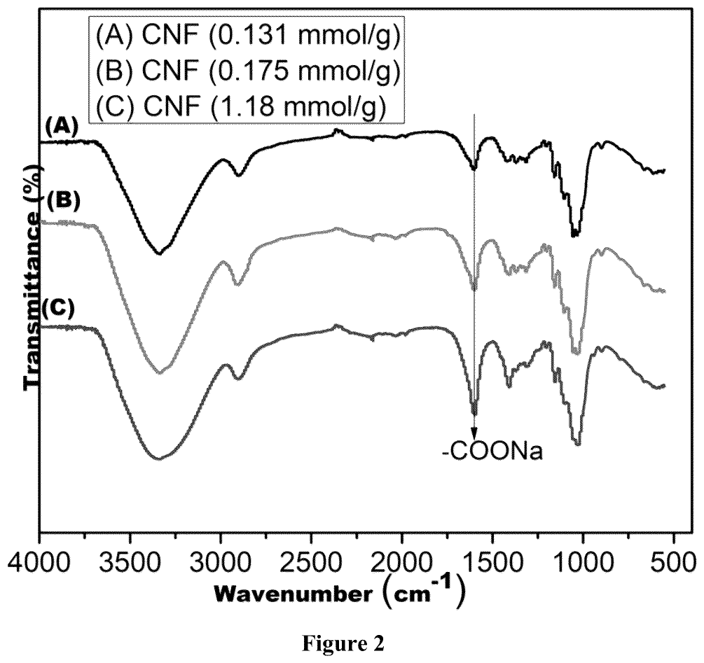

FIG. 2 shows the FTIR spectra of CNFs having different carboxylate content. All CNFs exhibited similar peaks due to cellulose chains, such as 3328 cm⁻¹ from the OH stretching and 2900 cm⁻¹ from the C—H symmetrical stretching. However, it was found that the OH stretching peak at 3328 cm⁻¹ in CNF (1.18 mmol/g) became much broader compared to the OH stretching peak in CNF (0.131 mmol/g) and CNF (0.175 mmol/g). This is due to the disturbance in the hydrogen bonding from modifying the C6 primary hydroxy to the carboxyl group in cellulose. This modification was more pronounced in CNF (1.18 mmol/g) due to the presence of a higher amount of carboxyl groups than those in CNF (0.131 mmol/g) and CNF (0.175 mmol/g). Specifically, the peak at 2900 cm⁻¹ from the C—H stretching decreased, and the peak at 1588 cm⁻¹ from the COONa vibration increased as the carboxylate content increased.

The above results confirmed that the TEMPO-oxidation process with excess NaClO can effectively oxidize the C6 hydroxyl group in the anhydroglucose unit. However, the peaks relevant to xylan and glucomannan of hemicellulose units, such as at 1460, 1240, and 810 cm⁻¹, still appeared in the resulting CNFs. This indicates the presence of residual hemicellulose in the prepared samples. Notably, no peaks relevant to the lignin component appeared in the FTIR spectra of these CNFs. This contradicts the results of the quantitative analysis, which showed that all CNFs contained some residual lignin. However, the quantitative analysis in Table 1 confirmed the presence of residual lignin and hemicellulose. This indicates that quantitative analysis is more promising in measuring the subcomponents in raw biomass as it involves the dissolution of the samples.

Example 4. Carbon-13 Cross-Polarization Magic Angle Spinning Nuclear Magnetic Resonance (¹³C CPMAS NMR). Solid state ¹³C CPMAS NMR of virgin jute fibers and resulting CNFs were carried out by a Bruker Ultrashield 500WB plus (500 MHZ) NMR instrument, equipped with a 2.5 mm triple MAS NMR probe, capable of spinning samples up to 35 KHz. The resonance frequency for ¹³C was 10,000 Hz, and the samples were spun at the magic angle with a speed of 10 KHz.

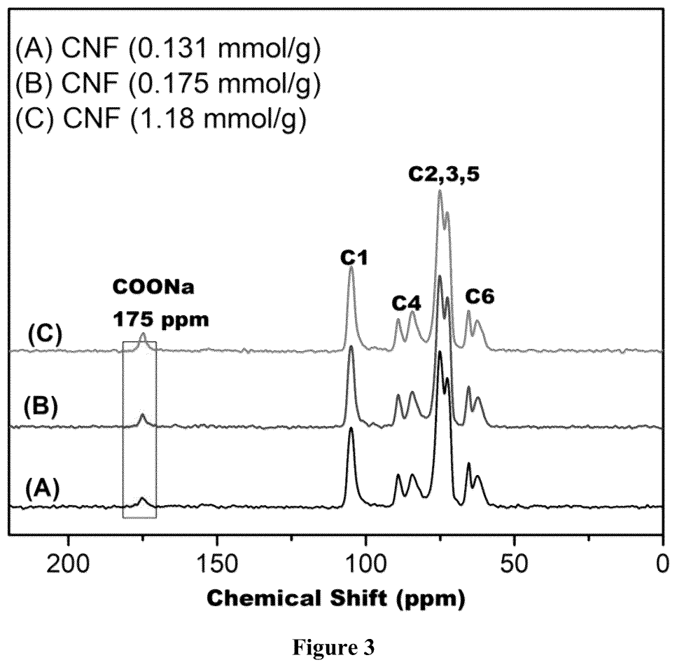

The solid-state ¹³C CPMAS NMR spectra of CNFs are illustrated in FIG. 3. All prepared CNFs showed the cellulose I structure. (Sharma et al. 2017a, b) The peaks between 60-70 ppm and 70-80 ppm are attributed to the C6 carbon of the primary alcohol group and the C2, C3, and C5 carbons of the cellulose chains, respectively. Meanwhile, the peaks between 80-95 ppm contribute to C4 carbon, and the distinct peak between 100 and 110 ppm is assigned as the anomeric C1 carbon. Notably, all CNFs exhibited the carboxylate peak at 175 ppm, confirming the oxidation of the hydroxyl group in the C6 position of the anhydroglucose unit.

Example 5. Thermogravimetric Analysis (TGA). A Perkin Elmer STA-6000 instrument was used to study the thermal stability of virgin jute and the resulting CNF. Both TGA and differential thermogravimetry (DTG) curves were measured. The samples were run at a 10° C./min heating rate in the 30-850° C. range under a continuous nitrogen flow.

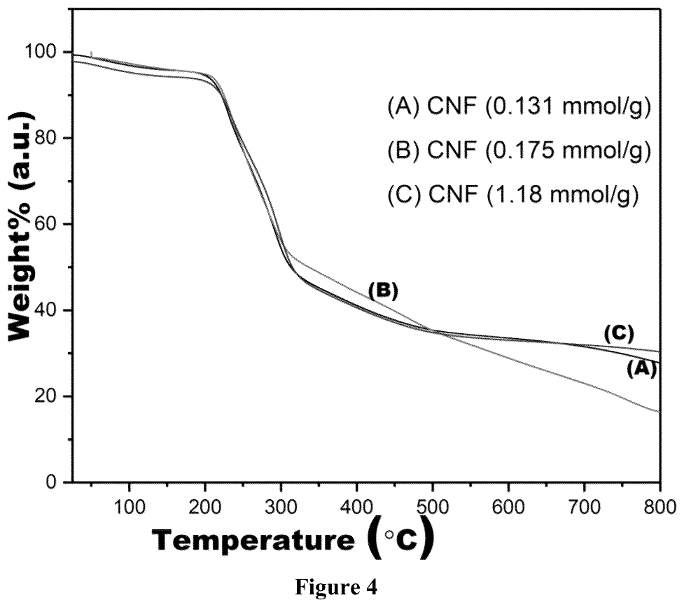

The thermogravimetric analysis (TGA) and derivative thermogravimetric (DTG) of CNFs are shown in FIG. 4. The initial onset temperature (Tₒₙₛₑₜ) for degradation of CNF (1.18 mmol/g) occurred at 192° C. with 8 wt % weight losses, and the offset temperature (T_{offset}) was about 498° C. The Tₒₙₛₑₜ observed for CNF (0.175 mmol/g) appeared at 205° C. with 7% weight loss, and the T_{offset} appeared at 520° C. However, the Tₒₙₛₑₜ observed for CNF (0.131 mmol/g) was the highest at 209° C. with weight loss of 6%, where the corresponding T_{offset} was at 530° C. The results show that among all three extracted CNFs, CNF (0.131 mmol/g) is the most thermally stable material. Interestingly, the residual weight obtained for all CNFs at 800° C. was 15-29 wt %. These values were higher than the residual weight obtained from raw jute fibers. (Sharma et al. 2017a, b) This is perhaps because of residual lignin and hemicellulose in CNFs, which may have been modified into a cross-linked product during thermal degradation. Also, sodium ions in CNFs may have increased the residual weight.

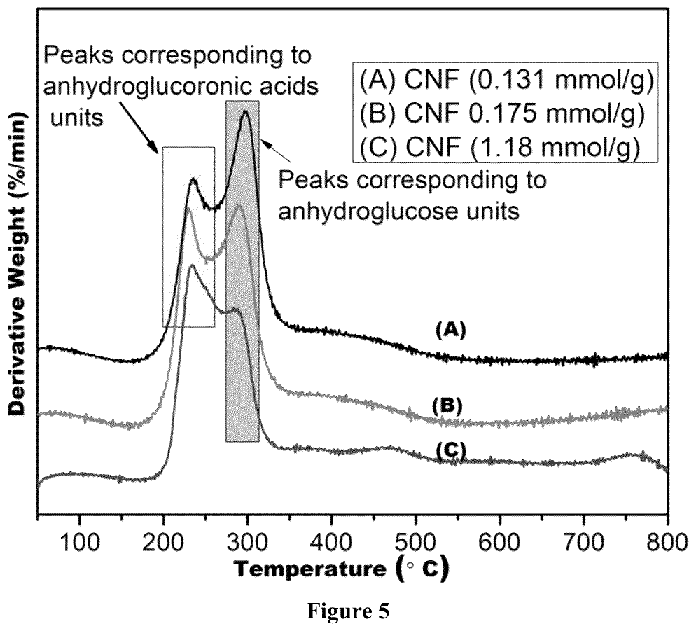

In FIG. 5, the DTG decomposition curve of CNFs exhibited two peaks, where the lower temperature peak is attributed to the decomposition of anhydroglucoronic acid moieties (Sharma et al. 2014a, b, c) and hemicellulose (Liu et al. 2014) units. In CNF (0.131 mmol/g), this peak occurred at 233° C., while in CNF (0.175 mmol/g), it occurred at 229° C., and in CNF (1.18 mmol/g), it also occurred at 233° C. The other temperature peak in DTG occurred at 470-449° C., corresponding to the degradation of lignin (Sharma et al. 2017a, b).

Example 6. Wide-Angle X-ray Diffraction (WAXD). X-ray diffraction measurements were carried out using a 2nd Generation Bruker D2 Phaser X-ray Diffractometer. The samples were prepared by coating CNF on the glass sample holders. Using a Ni filter, the Cu Kα radiation was generated at 40 kV and 40 mA (2=0.154 nm). Data was collected using a flat holder in a Bragg-Brentano geometry (5-50°; 10° min 1). The crystallinity index (CrI) was calculated by using the XRD amorphous subtraction method, which was outlined by Ruland (see Sharma & Varma, 2014). In this method, CrI was calculated as the ratio of the area of the crystalline domain to the total area as expressed by the following equation:

$$\begin{matrix}Crl = \frac{( {I}_{t o t a l} - {I}_{a m} )}{{I}_{t o t a l}} & \end{matrix} \qquad Eq . 1$$

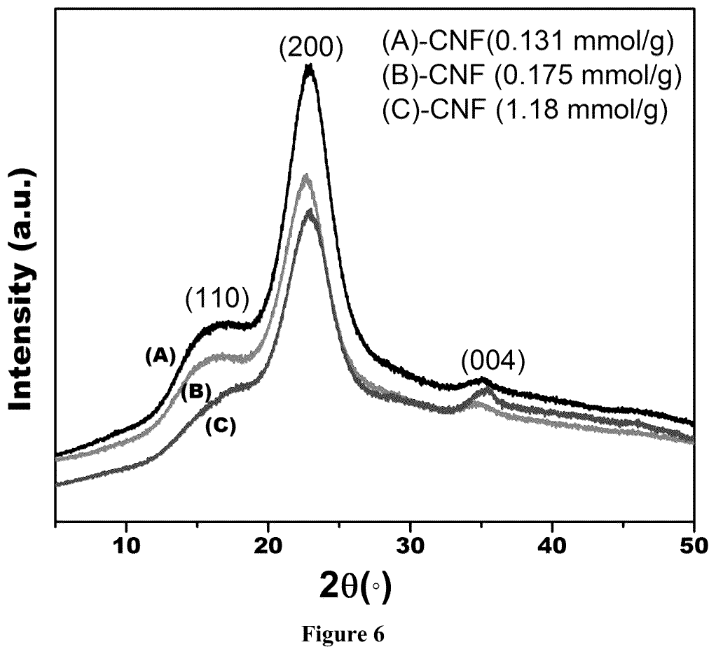

WAXD patterns from extracted CNFs are illustrated in FIG. 6. These patterns indicate the cellulose I structure, whereby the peaks appeared at 2θ of 16.4°, 23.02°, and 35.4° are assigned to the (110), (200), and (004) reflection planes, respectively. We note that the diffraction peaks related to the [symbol] and (102) planes of cellulose I structure were not seen in the WAXD patterns. (Sharma et al. 2014a, b) It is conceivable that the presence of residual hemicellulose and lignin, surrounding the nascent cellulose crystals (i.e., elementary microfibrils) can disrupt the intermolecular hydrogen bonding plane, leading to the disappearance of the [symbol] peak. The main WAXD peak of cellulose I structure at 20) (22.8° due to the (200) plane indicates preserving the distance between the hydrogen-bonded sheets. The crystallinity index (CrI) of each extracted CNF was calculated using the Segal equation given in Eq. 1. The estimated CrI for CNF (0.131 mmol/g) was 64%, CNF (0.175 mmol/g) was 59.4%, and CNF (0.175 mmol/g) was 59.3%. At the same time, the CrI from the initial raw jute fibers was 62%. (Sharma et al. 2017a, b) This indicates that the surface of the CNF has become less ordered due to the TEMPO oxidation process, even though some contents of lignin and hemicellulose have been removed.

Example 7. Transmission Electron Microscopy (TEM) and Atomic Force Microscopy (AFM). TEM studies of CNFs were carried out by an FEI Tecnai G2 Spirit BioTWIN instrument, operated at an accelerating voltage of 120 kV and equipped with a digital camera. The instrument also possesses photographic film capability with goniometer and tilt stage accessories and electron diffraction capability. In typical sample preparation, a 10 μL aliquot sample of 0.01 wt % was deposited on freshly glow discharged carbon-coated Cu grids (300 mesh, Ted Pella Inc.), followed by staining with 2 wt % aqueous uranyl acetate solution.

AFM measurements were performed using a Bruker Dimension ICON scanning probe microscope (Bruker Corporation, U.S.A.) equipped with a Bruker OTESPA tip (tip radius (max.)=10 nm). A 10 μL of 0.005 wt % CNF suspension was deposited on the surface of a silica plate, where the air-dried sample was measured in the tapping mode.

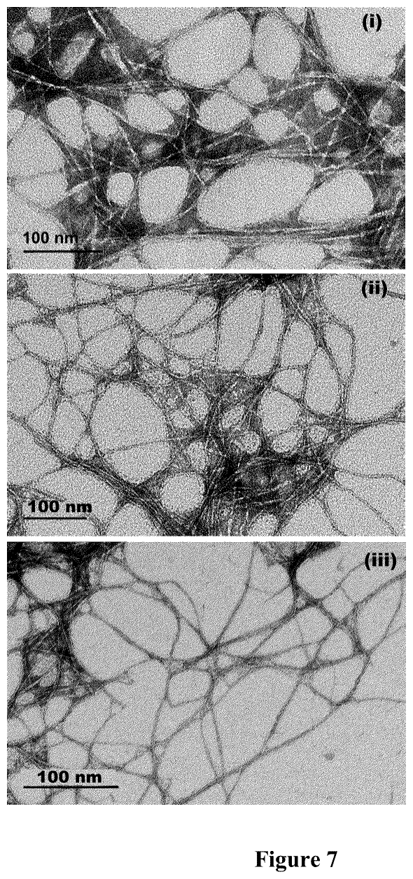

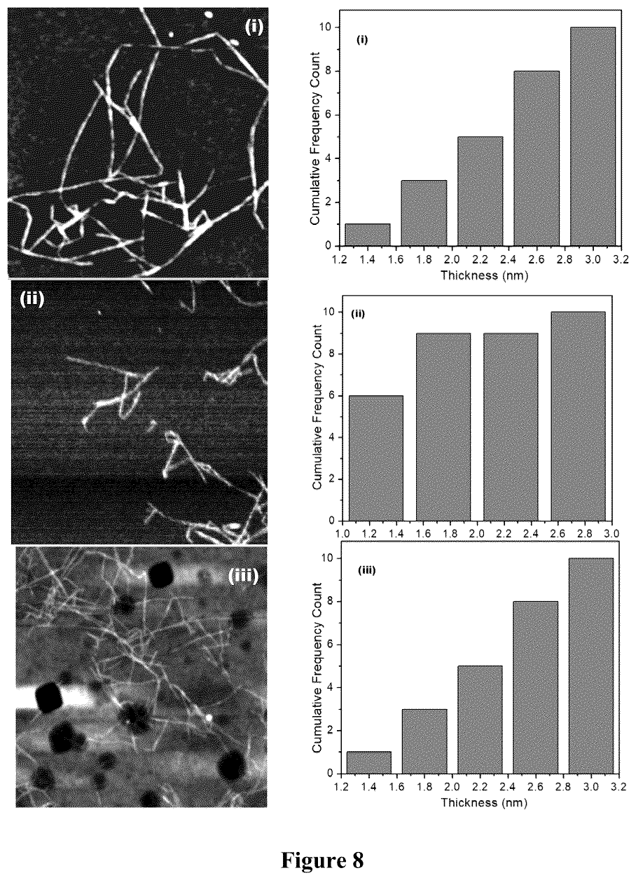

The morphological characterization of CNFs was performed using the TEM and AFM techniques, and the results are shown in FIGS. 7 and 8, respectively. In FIG. 7, the representative TEM images show that all extracted CNFs possessed high aspect ratios. From these images, the average fiber length (L) and fiber width (W) were estimated (i.e., 20 fibers from three different images of each sample were used for the averaging). The results indicate that: (i) CNF (0.131 mmol/g) possessed an average L of 1038±120 nm and W of 6.8±1.3 nm, while CNF (0.175 mmol/g) has an average L of 878±90 and W of 6.5±1.9 nm, and CNF (1.18 mmol/g) showed average L of 620±110 and W of 6.3±2.2 nm. The decrease in the length of CNF with an increase in the carboxylate content usually happens due to a decrease in the degree of polymerization, which could be because of the use of high NaClO concentration.

The thickness of CNFs was estimated by the AFM measurements (using the tapping mode), where the representative AFM images and the histogram of the thickness distributions of all CNFs are shown in FIG. 8. It is found that the average thickness of CNFs is in the range of 2.8-3.2 nm.

Example 8. Preparation of Nanopaper. To further assess the properties of the CNFs produced by our method, nanopapers from the CNF suspensions were prepared by vacuum filtration using a microfiltration assembly comprised of an ultra-ware glass funnel connected to a vacuum pump, where the funnel was fitted with a Durapore® membrane filter paper having a diameter of 47 mm and an average pore size of 0.65 μm. (Sharma, et al. 2018) In preparation, 200 mL of 0.2 wt % of the CNF suspension was slowly poured into the funnel using a glass rod to avoid forming air bubbles. The aggregation of the CNF layer was formed continuously on top of the membrane paper until a uniform wet sheet of CNF nanopaper was achieved. The wet nanopaper sheet was removed from the membrane support, placed between two Kapton films, and hot-pressed at 111° C. for 20 minutes. To avoid the wrinkling of the nanopaper edges, the resulting nanopapers were compressed under 1 kg of weight at room temperature for 16 h and then tested for the contact angle measurement.

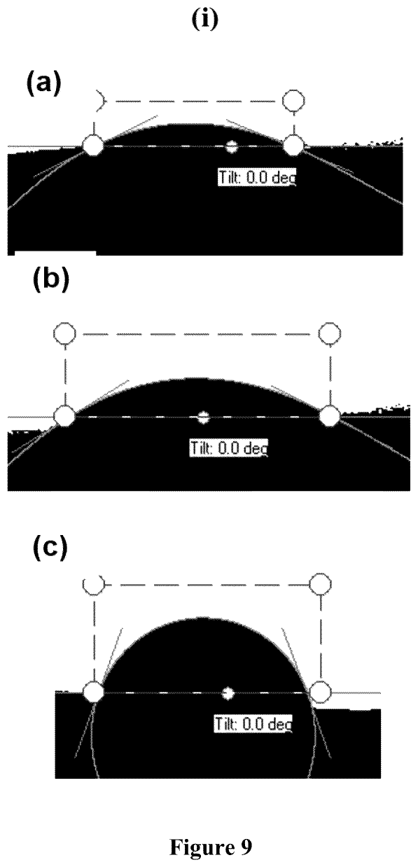

Nanopapers prepared from different CNFs were also evaluated for hydrophilicity using the contact angle technique, where the results are illustrated in FIG. 9. In this figure, CNF (0.131 mmol/g) showed an average contact angle of 23.5°, CNF (0.175 mmol/g) showed a contact angle of 29°, and CNF (1.18 mmol/g) showed a contact angle of 69°. The higher degree of contact angle represents higher hydrophobicity. This indicates that the nanopaper made of CNF (0.131 mmol/g) was the most hydrophilic, and the nanopaper of CNF (1.18 mmol/g) was the most hydrophobic. This finding contradicts the consideration of carboxylate content since the increase in carboxylate groups usually increases hydrophilicity. (Khakalo et al. 2020) The CNFs possess the carboxylate groups as the sodium salt of carboxylic acid. Hence, the higher content of carboxylate groups in CNF (1.18 mmol/g) demonstrated a higher contact angle with high hydrophobicity.

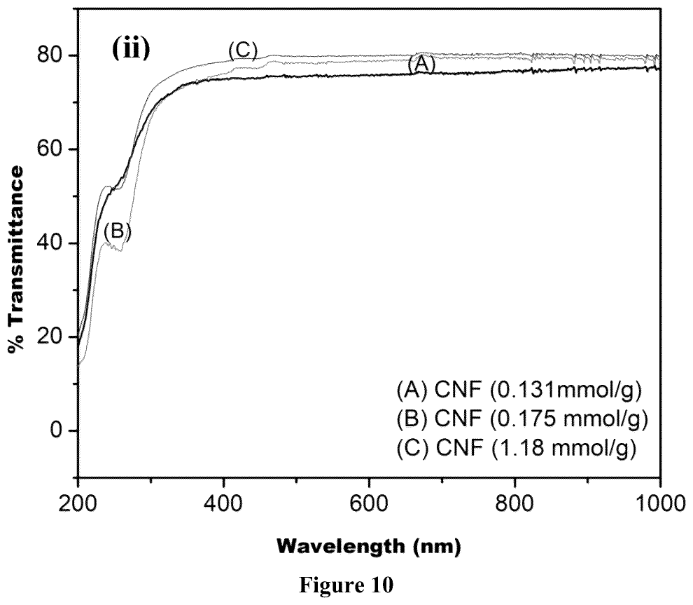

The light transmittance results from different CNF nanopapers are shown in FIG. 10. These measurements were carried out to determine the effects of carboxylate content on the CNF nanopaper. CNFs with higher carboxylate content have been reported to present excellent light transmittance. (Wei et al. 2016) For example, nanopapers produced from bamboo pulps using TEMPO oxidation to extract CNF with carboxylate content of 1.8 mmol/g showed a transmittance of ˜98%, while CNF with carboxylate content of 1.0 mmol/g showed a transmittance of ˜75%. In the example embodiments, CNF (1.18 mmol/g), having the highest carboxylate content, showed a transmittance value of 80% at a wavelength of 600 nm. Similarly, CNF (0.131 mmol/g) and CNF (0.175 mmol/g) exhibited transmittance values of 76 and 79%, respectively. This indicates that not much difference in transmittance in all CNF membranes is seen, probably because of the similar content of residual lignin in the 2-4 wt % range.

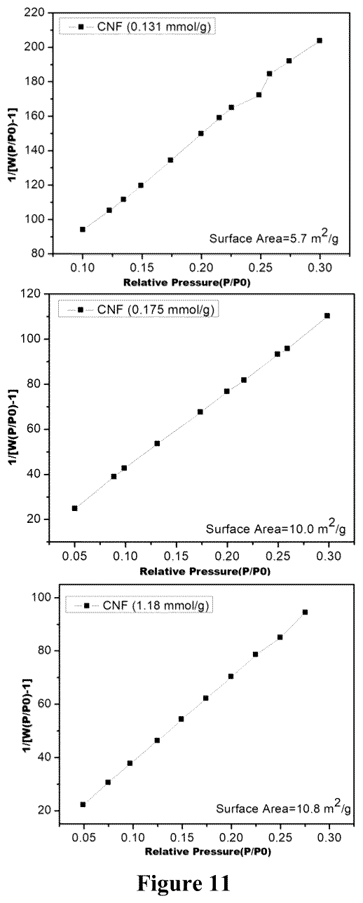

The surface area of the CNF nanopaper was assessed by Brunauer-Emmett-Teller (BET) measurements. The corresponding BET profiles of all three CNF nanopapers are shown in FIG. 11. It is seen that CNF (0.131 mmol/g) exhibited a surface area of 5.7 m²/g, which is lower than CNF (0.175 mmol/g) and CNF (1.18 mmol/g). Interestingly, CNF (0.175 mmol/g) and CNF (1.18 mmol/g) did not show much difference in the surface area, which was 10 m²/g and 10.8 m²/g, respectively.

Table 1 presents the characteristics and properties of all CNF samples prepared using the current TEMPO/NaBr/NaClO oxidation method. This includes measurements related to carboxylate content, aldehyde content, zeta potential, BET surface area, and lignin. The CNF obtained by the addition of the lowest NaClO concentration, i.e., 24 mmol/g with carboxylate content of 0.131 mmol/g, exhibits the minimum zeta potential of −110 mV, which is the lowest negative charge among all the three prepared CNFs. A small amount of aldehyde of 0.10 mmol/g was observed in this sample, which was termed as CNF (0.131 mmol/g).

Notably, the CNF obtained using the increased amount of NaClO with 32 mmol/g showed a negative surface charge of −114 mV and a carboxylate content of 0.175 mmol/g along with the aldehyde content of 0.18 mmol/g. This CNF sample was termed as CNF (0.175 mmol/g). On further increase in the NaClO concentration to 48 mmol/g, the carboxylate and aldehyde content of CNF increased to 1.18 and 1.50 mmol/g, respectively. The corresponding zeta potential obtained was −148 mV; this sample is termed CNF (1.18 mmol/g). These results directly impact cellulose oxidation with an increased NaClO amount under the current TEMPO-oxidation condition, likely because NaClO acts as an effective oxidant. (Saito et al. 2006a, b) This would not have any significant negative impact on the sustainability of this process, as NaClO is a low-cost chemical, and recycling this chemical is also easy. (Xu et al. 2023) The increase in aldehyde content in CNFs when moving from CNFs (0.131 mmol/g) to CNFs (1.18 mmol/g) could be due to an increase in endpoints in cellulose chains as the degradation may have fastened on increasing the amount of NaClO.

Summary. The starting virgin jute fiber included lignin at 17.6%, hemicellulose at 11.7%, and cellulose at 56.6%. Table 1 indicates that the use of excess NaClO in the TEMPO/NaBr/NaClO oxidation has led to the removal of 88-89% lignin and 78-80% hemicellulose along with toxidation of the cellulose fibers, which varied from 0.131-1.81 mmol/g. Interestingly, excess NaClO ranging from 24 to 48 mmol/g did not significantly increased the removal of lignin and hemicellulose that 24 mmol/g. It was anticipated that this amount would efficiently remove the surface lignin and hemicellulose and reach the cellulose surface oxidation to 0.131 mmol/g.

The further increase in NaClO significantly increased the carboxylate content of cellulose fibers from 0.175 to 1.81 mmol/g when NaClO was used at 32 and 48 mmol/g. Not to be limited by theory, but it is thought this occurred because the initial reaction of NaClO occurred at the surface components, i.e., lignin and hemicellulose. Once the cellulose fibers were exposed, the reaction of NaClO, along with other reagents, caused the oxidation of hydroxyl groups of cellulose, leading to the simultaneous increase in the carboxylate content, as presented in Table 1. The increase in carboxylate content (negative surface charge) is again evidenced by the zeta potential values, which vary from −110 to −148 mmol/g with CNFs (0.131 to 1.18 mmol/g).

These observations can be explained by the mechanisms of TEMPO oxidation on cellulose and hemicellulose, as illustrated in FIG. 1. During the pulping of raw biomass using NaClO, chlorine gas can be generated in the presence of acid, which is responsible for the degradation of the lignin components. However, NaClO, in the presence of TEMPO/NaBr, also acts as the primary oxidant, causing the generation of nitroxonium ions. These nitroxonium ions can lead to the oxidation of both cellulose and hemicellulose components simultaneously. Specifically, the nitroxonium ions can selectively oxidize the primary hydroxyl groups in both cellulose and hemicellulose chains (FIG. 1).

Additionally, the nitroxonium ions probably attack the hemicellulose chains more predominantly than the cellulose chains because hemicellulose is more exposed in the cell wall of the raw biomass. Furthermore, the TEMPO/NaClO/NaBr catalytic cycle liberates C1-ions from NaClO, thus also affecting the removal of lignin. Table 1 indicates that the combination of TEMPO/NaClO/NaBr, even at a concentration of 24 mmol/g, effectively removes the overall lignin and hemicellulose by more than 90%. Further addition of NaClO to 32 and 48 mmol/g did not greatly improve the removal of lignin and hemicellulose. This indicates that the current process is more promising for developing lignocellulosic nanofibers than pure nanocellulose fibers.

The present disclosure describes updated TEMPO-oxidation conditions to extract cellulose nanofibers from a virgin plant fiber (i.e., jute fibers without pre-treatment). This approach aims to combine the steps of pulping (delignification) and cellulose oxidation to induce nanofibrillation of microfibers. In some aspects, the modification scheme mainly involved using 5-8 times higher concentrations of NaClO as in the typical TEMPO/NaBr/NaClO process to produce CNF in a one-pot reaction. Interestingly, adding NaClO in the 32-48 mmol/g range effectively removes hemicellulose and lignin and oxidizes cellulose fibers. The updated TEMPO/NaBr/NaClO can generate oxidation in the 0.8-1.18 mmol/g range. This method was updated on jute fibers having lignin and hemicellulose of 17.6 and 11.7 wt %, respectively. The resulting degree of oxidation, residual lignin, and hemicellulose in extracted CNFs may vary depending on the other virgin plant fibers. More NaClO may be required for virgin plant fibers having higher lignin and hemicellulose content to achieve this method's maximum efficiency.

The present method allows virgin plant fibers without pretreatment and bleaching, significantly saving energy and cost. It is noted that a high concentration of NaClO is used to perform the delignification, bleaching, and oxidation of virgin fibers in one pot. However, NaClO is not an expensive chemical, and its recycling is easy. Hence, this study further enhances the sustainability of the existing TEMPO/NaBr/NaClO method to extract the high aspect ratio carboxycellulose nanofibers from untreated/virgin fibers.

1. A method to produce carboxylate-rich lignified cellulose nanofibers from plant fiber biomass, comprising:
combining plant fiber biomass, TEMPO agent and NaBr in water;
adding NaClO to said water, at a concentration of at least 20 mmol per g of biomass to form a reaction mixture;
obtaining a reacted plant fiber biomass;
homogenizing the reacted plant biomass to form carboxylate-rich lignified cellulose nanofibers.

2. The method of claim 1, wherein obtaining a reacted plant fiber biomass further comprises quenching the reaction with an alcohol.

3. The method of claim 2, wherein the alcohol is ethanol.

4. The method of claim 2, wherein the alcohol is added at about a 1:3 ratio to the original amount of water.

5. The method of claim 1, wherein obtaining a reacted plant biomass further comprises achieving a pH at about 10 to 10.5 in the reaction mixture.

6. The method of claim 1, wherein the plant fiber biomass is ground into fibers of about 2-4 mm or less.

7. The method of claim 1, wherein the plant fiber biomass is added to the reaction mixture at 2.0% wt/vol of water or less.

8. The method of claim 1, wherein the TEMPO agent is added to the reaction mixture at 0.1% wt/vol of water or less.

9. The method of claim 1, wherein the NaBr is added to the reaction mixture at 0.5% wt/vol of water or less.

10. The method of claim 1, wherein the NaClO is added to said water, at a concentration of at least 24 mmol per g of biomass.

11. The method of claim 1, wherein the NaClO is added to said water, at a concentration of about 20-50 mmol per g of biomass.

12. The method of claim 1, wherein the carboxylate-rich lignified cellulose nanofibers have an overall removal of lignin and hemicellulose by more than 90%, compared to the initial plant fiber biomass.

13. The method of claim 1, wherein the carboxylate-rich lignified cellulose nanofibers have a carboxylate content of about 1.30 mmol/g or more.
